(19) United States
(12) Patent Application Publication
(10) Pub. No.: US 2007/0036121 A1
(43) Pub. Date: Feb. 15, 2007

(54) Method and apparatus for providing reverse activity information in a multi-carrier communication system

(76) Inventors: George Cherian, San Diego, CA (US); Jigneshkumar Shah, San Diego, CA (US)

Correspondence Address: DITTHAVONG & MORI, P.C., Suite A, 10507 Braddock Road, Fairfax, VA, 22032, US

(21) Appl. No.: 11/395,450

(22) Filed: Mar. 31, 2006

Related U.S. Application Data
(60) Provisional application No. 60/707,741, filed on Aug. 12, 2005.

(51) Int. Cl. H04B 7/216

(52) U.S. Cl. 370/342; 370/209

(57) ABSTRACT

An approach is provided for signaling in multi-carrier system. Multiple reverse activity channels are dynamically assigned to one or more carriers of a forward link, wherein the reverse activity channels transport information about a corresponding plurality of carriers of a reverse link. A message is generated for specifying information about the channel assignments and the information about the reverse link carriers.

### RELATED APPLICATIONS

This application claims the benefit of the earlier filing date under 35 U.S.C. §119(e) of U.S. Provisional Application Serial No. 60/707,741 filed Aug. 12, 2005, entitled “Method and Apparatus for Providing Reverse Activity Information in a Multi-carrier Communication System,” the entirety of which is incorporated by reference.

### FIELD OF THE INVENTION

Embodiments of the invention relate to communications, and more particularly, to a multi-carrier communication system.

### BACKGROUND

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves extending mobile services to provide users with seamless delivery of mobile voice and data services. Namely, such efforts have concentrated on systems that employ a single carrier for the forward link and a single carrier for the reverse link. However, user demand for greater throughput has steered efforts towards multi-carrier systems. Among the many challenges, this demand requires coexistence with the current standards framework for single carrier systems. Moreover, it is recognized that the number of carriers for the forward link and that for the reverse link can differ, giving rise to an asymmetric system.

Therefore, there is a need for an approach to provide an efficient signaling scheme for supporting asymmetric channel assignment, with minimal modification of existing standards and protocols.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a wireless system including an Access Network (AN) and an Access Terminal (AT) configured to support asymmetric carriers for the forward link and the reverse link, in accordance with an embodiment of the invention;

FIGS. 2-4 are flowcharts of exemplary processes for providing reverse activity information to support multiple carriers for the reverse link, according to various embodiments of the invention;

FIGS. 5A-5C are diagrams of exemplary traffic channel assignment messages, in accordance with various embodiments of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

These and other needs are addressed by the embodiments of the invention, in which an approach is presented for providing reverse activity information to access terminals capable of employing multiple carriers for transmission over a reverse link.

An apparatus, method, and software for providing reverse activity information to access terminals capable of employing multiple carriers for transmission over a reverse link are disclosed. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the embodiments of the invention.

Although the invention, according to various embodiments, is discussed with respect to a radio communication network (such as a cellular system), it is recognized by one of ordinary skill in the art that the embodiments of the invention have applicability to any type of communication systems, including wired systems. Additionally, the various embodiments of the invention are explained using Walsh codes as channel identifiers, it is recognized by one of ordinary skill in the art that other orthogonal codes can be utilized.

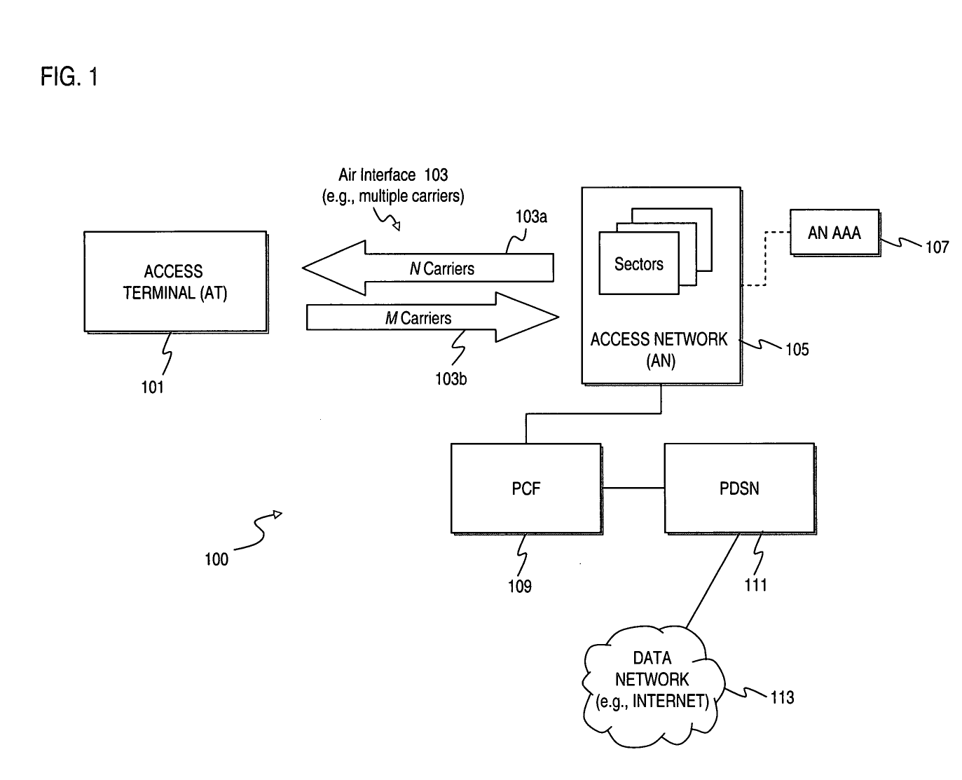

FIG. 1 is a diagram of the architecture of a wireless system including an Access Network (AN) and an Access Terminal (AT) configured to support asymmetric carriers for the forward link and the reverse link, in accordance with an embodiment of the invention. By way of example, a radio network operates according to the Third Generation Partnership Project (3GPP) cdma2000 Multi-Carrier Requirements in Code Division Multiple Access (CDMA) NxEV-DO (Evolution Data-Only) networks, and provides High Rate Packet Data (HRPD) services. The radio network 100 includes one or more access terminals (ATs) 101 of which one AT 101 is shown in communication with an access network (AN), or base station, 105 over an air interface 103. In cdma2000 systems, the AT is equivalent to a mobile station, and the access network is equivalent to a base station. The air interface 103 provides multiple carriers in the forward link 103a as well as the reverse link 103b.

The AT 101 is a device that provides data connectivity to a user. For example, the AT 101 can be connected to a computing system, such as a personal computer, a personal digital assistant, and etc. or a data service enabled cellular handset. The radio configuration encompasses two modes of operations: 1×and multi-carrier (i.e., nX or N number of carriers). Multi-carrier systems (e.g., system 100) employ multiple 1×carriers to increase the data rate to the AT 101 (or mobile station) over the forward link. Hence, unlike 1×technology, the multi-carrier system operates over multiple carriers. In other words, the AT 101 is able to access multiple carriers simultaneously.

A connection can be defined as a particular state of the air-link in which the AT 101 is assigned a Forward Traffic Channel, a Reverse Traffic Channel and associated Medium Access Control (MAC) Channels. During a single HRPD session, the AT 101 and the AN 105 can open and can close a connection multiple times. An HRPD session refers to a shared state between the AT 101 and the AN 105. This shared state stores the protocols and protocol configurations that were negotiated and are used for communications between the AT 101 and the AN 105. Other than to open a session, the AT 101 cannot communicate with the AN 105 without having an open session. A more detailed description of the HRPD is provided in 3GPP2 C.S0024-A, entitled “cdma2000 High Rate Packet Data Air Interface Specification,” March 2004, 3GPP2 A.S0007-A v2.0, entitled “Interoperability Specification (IOS) for High Rate Packet Data (HRPD) Access Network Interfaces—Rev. A,” May 2003, and 3GPP2 A.S0008-0 v3.0, entitled “Interoperability Specification (IOS) for High Rate Packet Data (HRPD) Access Network Interfaces,” May 2003; which are incorporated herein by reference in their entireties.

The AN 105 is a network equipment or network element that provides data connectivity between a packet switched data network, such as the global Internet 113 and the AT 101. In addition, the AN 105 communicates with an AN-AAA (Authentication, Authorization and Accounting entity) 107, which provides terminal authentication and authorization functions for the AN 105.

According to various embodiments, the AN 105 includes a High Data Rate (HDR) base station to support high data rate services. It should be understood that the base station provides the RF interface (carrier(s)) between an access terminal and the network via one or more transceivers. The HDR base station provides a separate data only (DO) carrier for HDR applications for each sector (or cell) served by the HDR base station. A separate base station or carrier (not shown) provides the voice carrier(s) for voice applications. A HDR access terminal may be a DO access terminal or a dual mode mobile terminal capable of utilizing both voice services and data services. To engage in a data session, the HDR access terminal connects to a DO carrier to use the DO high-speed data service. The data session is controlled by a Packet Data Service Node (PDSN), which routes all data packets between the HDR access terminal and the Internet. The PDSN has a direct connection to a Packet Control Function (PCF) 109, which interfaces with a Base Station Controller (BSC) of the HDR base station. The BSC is responsible for operation, maintenance and administration of the HDR base station, speech coding, rate adaptation and handling of the radio resources. It should be understood that the BSC may be a separate node or may be co-located with one or more HDR base stations.

Each HDR base station can serve multiple (e.g., three) sectors (or cells). However, it should be understood that each HDR base station may serve only a single cell (referred to as an omni cell). It should also be understood that the network may include multiple HDR base stations, each serving one or more sectors, with HDR mobile terminals being capable of handing off between sectors of the same HDR base station or sectors of different HDR base stations. For each sector (or cell), the HDR base station further employs a single shared, time division multiplexed (TDM) forward link, where only a single HDR mobile terminal is served at any instance. The forward link throughput rate is shared by all HDR mobile terminals. A HDR access terminal selects a serving sector (or cell) of the HDR base station by pointing its Data Rate Control (DRC) towards the sector and requesting a forward data rate according to the channel conditions (i.e., based on the Carrier to Interference (C/I) ratio of the channel).

As shown, the AN 105 communicates with a Packet Data Service Node (PDSN) 111 via a Packet Control Function (PCF) 109. Either the AN 105 or the PCF 109provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety. Also, a more detailed description of the HRPD is provided in TSG-C.S0024-IS-856, entitled “cdma2000 High Rate Packet Data Air Interface Specification,” which is incorporated herein by reference in its entirety.

Both the cdma2000 1xEV-DV (Evolution—Data and Voice) and 1xEV-DO (Evolution—Data Optimized) air interface standards specify a packet data channel for use in transporting packets of data over the air interface (e.g., interface 103) on the forward link and the reverse link. A wireless communication system (e.g., system 100) may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals.

In the multiple-access wireless communication system 100, communications between users are conducted through one or more AT(s) 101 and a user (access terminal) on one wireless station communicates to a second user on a second wireless station by conveying information signal on a reverse link to a base station. The AN 105 receives the information signal and conveys the information signal on a forward link to the AT station 101. The AN 105 then conveys the information signal on a forward link to the station 101. The forward link refers to transmissions from an AN 105 to a wireless station 101, and the reverse link refers to transmissions from the station 101 to the AN 105. The AN 105 receives the data from the first user on the wireless station on a reverse link, and routes the data through a public switched telephone network (PSTN) to the second user on a landline station. In many communication systems, e.g., IS-95, Wideband CDMA (WCDMA), and IS-2000, the forward link and the reverse link are allocated separate frequencies.

As mentioned, the system of FIG. 1 supports an asymmetric combination of “N” carriers on the forward link, and “M” carriers on the reverse link, wherein N and M represent integers. In an exemplary embodiment, the base station 105 indicates the reverse activity of a reverse link channel by transmitting “reverse activity bit” using reverse activity channel, which is a forward link channel. In traditional 1xHRPD systems, there is only one carrier on the reverse link; i.e., a channel identifier using an orthogonal code (e.g., Walsh code of W₂¹²⁸) is reserved for reverse activity channel. However, with the introduction of “M” carriers on the reverse link, “M” reverse activity channels are used.

The system of FIG. 1, in an exemplary embodiment, provides for the reservation of channel identifiers (e.g., Walsh-covers) for the reverse activity channels—that is, dynamic assignment of a Walsh cover for a reverse activity channel, per reverse link carrier. As noted, it is contemplated that other orthogonal codes can be utilized. The system 100 also provides dynamic association of reverse activity channels for “M” reverse link carriers to one or more forward link carriers. In an exemplary embodiment, extension of 128-length Walsh covers to 256-length Walsh covers for reverse activity channel is provided.

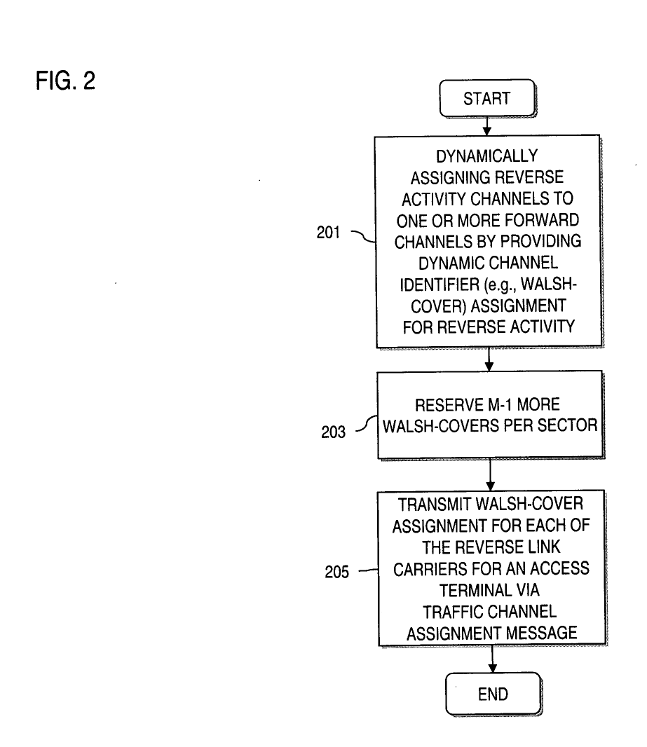

FIGS. 2-4 are flowcharts of exemplary processes for providing reverse activity information to support multiple carriers for the reverse link 103b, according to various embodiments of the invention.

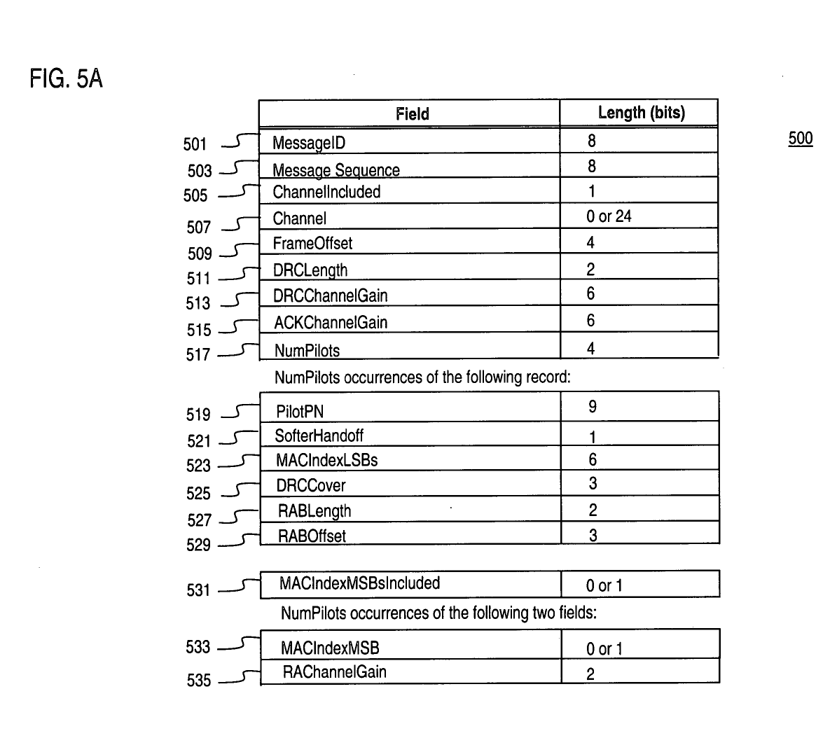

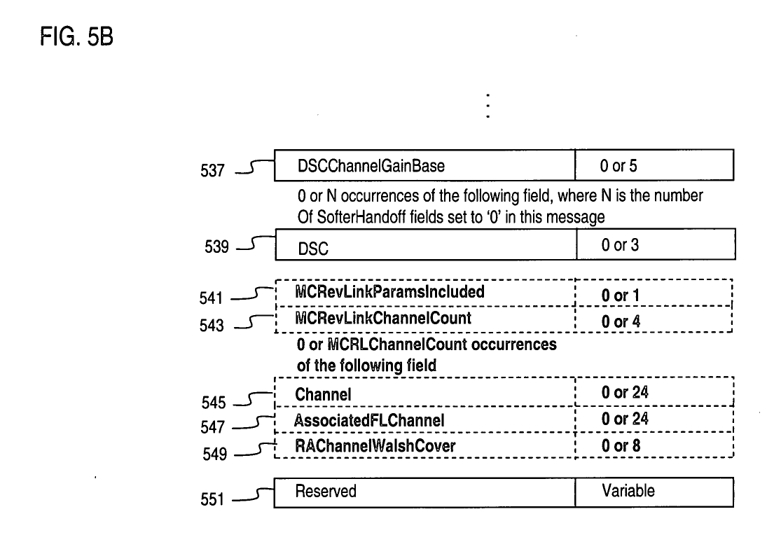

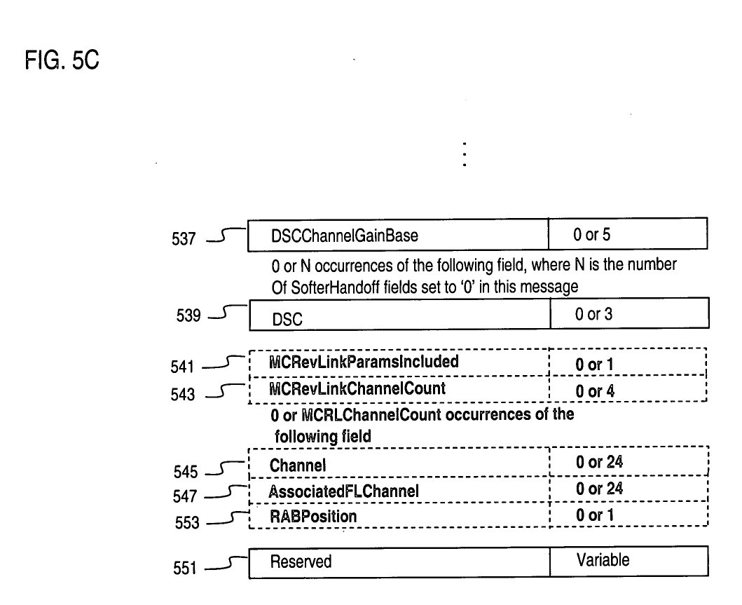

The process of FIG. 2 involves providing dynamic Walsh-cover assignment for the reverse activity channels, per step 201. In an exemplary embodiment, M-1 more Walsh-covers are reserved per sector, as in step 203. In step 205, the channel assignments, e.g., Walsh-cover assignment for each of the reverse link carriers, are transmitted to the access terminal 101. By way of example, a “Traffic Channel Assignment Message,” as shown in FIGS. 5A-5C, can be used to specify the channel assignments.

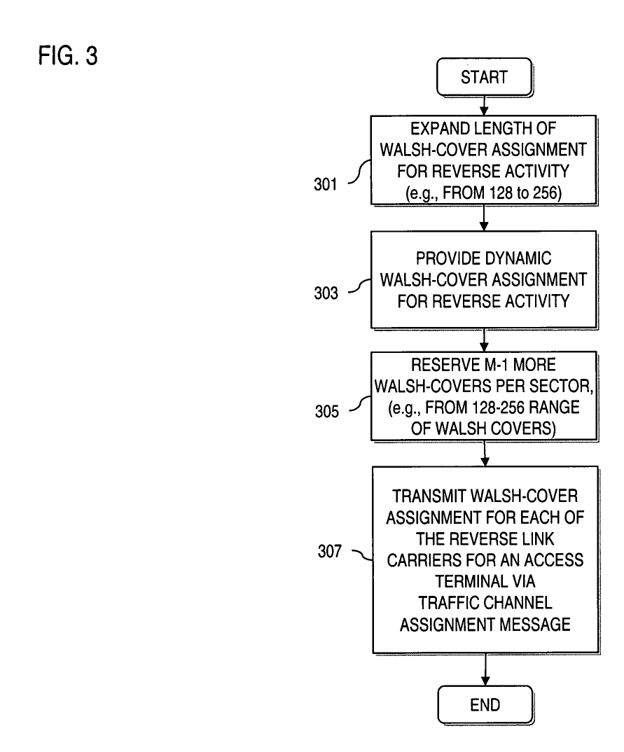

Another approach for providing reverse activity information is shown in FIG. 3. In this embodiment, the length of Walsh-cover-assignment is expanded, as in step 301, for the reverse activity channel, for example, to 256 from 128. As with the process of FIG. 2, the Walsh-cover assignment for reverse activity channel is dynamic (step 303). In step 305, M-1 additional Walsh-covers per sector are reserved (e.g., from 128-256 range of Walsh-covers). The Walsh cover assignment is transmitted, as in step 307, for each of the reverse link carrier for an access terminal using “Traffic Channel Assignment Message.”

With a any subtype of physical channel, the Reverse Activity (RA) Channel transmits the Reverse Activity Bit (RAB) stream over the MAC Channel with MACIndex 4. The RA bit is transmitted in every slot, and the RA bit in each slot is further repeated to form two symbols per slot for transmission.

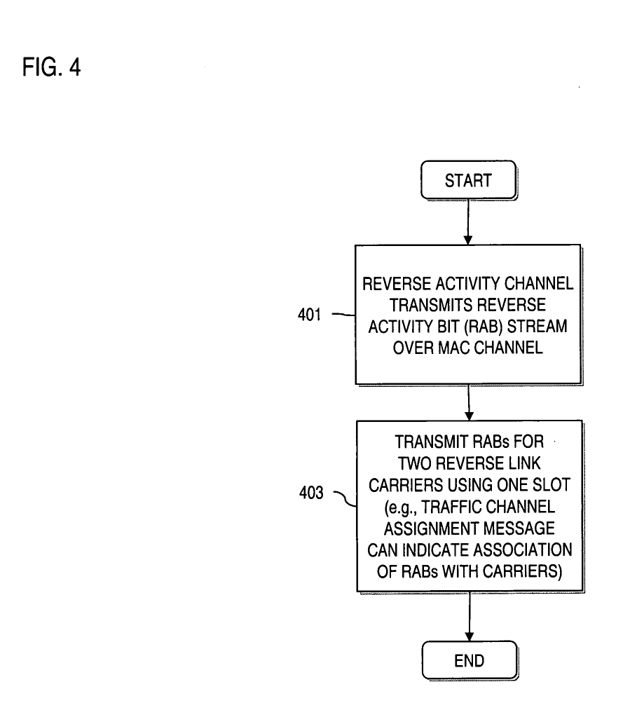

The approach of FIG. 4 utilizes one symbol per slot per reverse link carrier. In step 401, the reverse activity channel transmits the reverse activity bit (RAB) stream over the MAC channel. It is possible to transmit reverse activity bits for two Reverse Link (RL) carriers using one slot, e.g., RAB1 and RAB2 (step 403). The TrafficChannelAssignment message can indicate the association of RAB 1 and RAB2 with the corresponding RL carriers.

In the system of FIG. 1, a base station (within the Access Network) can send reverse activity bits for each of the reverse link, independently, in an asymmetric channel assignment (when the number of forward link carriers is different from that of the reverse link ones).

FIGS. 5A-5C, according to various embodiments of the invention, describe an exemplary format of the Traffic Channel Assignment message (denoted as “TrafficChannelAssignment”). FIG. 5A shows the beginning portions of the Traffic Channel Assignment message, while FIGS. 5B and 5C illustrate the remaining portions of the message, according to alternative embodiments. The embodiment of FIG. 5B utilizes a RAChannelWalshCover field (as in the processes of FIGS. 2 and 3), while the embodiment of FIG. 5C employs a RABPosition field (as in the process of FIG. 4).

Table 1 enumerates exemplary fields in the TrafficChannelAssignment format of FIGS. 5A-5C for providing reverse activity information in the asymmetric multi-carriers communication system of FIG. 1.

It is noted that different combinations of fields can be used for the format of the Traffic Channel Assignment message depending on the process (FIGS. 2-4).

TABLE 1

| RADIO LINK PROTOCOL | |
|---|---|
| ELEMENTS (FIELD) | DESCRIPTION |
| MessageID 501 | The access network can set this field to 0x01. |
| MessageSequence 503 | The access network can set this to 1 higher than the |
| | MessageSequence field of the last |
| | TrafficChannelAssignment message (modulo |
| | 2^{S}, S = 8) sent to this access terminal. |
| ChannelIncluded 505 | The access network can set this field to ‘1’ if |
| | the Channel record is included for these |
| | pilots. Otherwise, the access network can set |
| | this field to ‘0’. |
| Channel 507 | The access network can include this field if |
| | the ChannelIncluded field is set to ‘1’. The access |
| | network can set this to the channel |
| | record corresponding to this pilot. Otherwise, |
| | the access network can omit this field for this |
| | pilot offset. If channel is included, the access |
| | network can set the SystemType field of the |
| | Channel record to ‘0000’. |
| FrameOffset 509 | The access network can set this field to the |
| | frame offset the access terminal is to use |
| | when transmitting the Reverse Traffic |
| | Channel, in units of slots. |
| DRCLength 511 | The access network can set this field to the |
| | number of slots the access terminal is to use to transmit |
| | a single Data Rate Control (DRC) |
| | value, as shown in Table 2. |
| DRCChannelGain 513 | The access network can set this field to the |
| | ratio of the power level of the DRC Channel |
| | (when it is transmitted) to the power level of |
| | the Reverse Traffic Pilot Channel expressed |
| | as 2's complement value in units of 0.5 dB. |
| | For example, a valid range for this field can |
| | be from −9 dB to +6 dB, inclusive. The access |
| | terminal supports all the values in the valid |
| | range for this field. |
| ACKChannelGain 515 | The access network can set this field to the |
| | ratio of the power level of the ACK Channel |
| | (when it is transmitted) to the power level of |
| | the Reverse Traffic Pilot Channel expressed |
| | as 2's complement value in units of 0.5 dB. |
| | The valid range for this field is from −3 dB to |
| | +6 dB, inclusive. The access terminal |
| | supports all the values in the valid range for this field. |
| NumPilots 517 | The access network can set this field to the |
| | number of pilots included in this message. |
| PilotPN 519 | The access network can set this field to the |
| | PN Offset associated with the sector that will |
| | transmit a Power Control Channel to the |
| | access terminal, to whom the access terminal |
| | is allowed to point its DRC, and whose |
| | Control Channel and Forward Traffic |
| | Channel the access terminal may monitor. |
| SofterHandoff 521 | If the Forward Traffic Channel associated |
| | with this pilot will carry the same closed-loop |
| | power control bits as that of the previous pilot |
| | in this message, the access network can set |
| | this field to ‘1’; otherwise, the access network |
| | can set this field to ‘0’. The access network |
| | can set the first instance of this field to ‘0’. If |
| | the SofterHandoff field associated with a |
| | PilotPN is equal to ‘1’, then the Pilot PN is |
| | defined to belong to the same cell as the previous |
| | PilotPN in this message. |
| MACIndexLSBs 523 | Least Significant Bits of the Medium Access |
| | Control Index. The access network can set |
| | this field to the six least significant bits of the |
| | MACIndex assigned to the access terminal by |
| | this sector. |
| DRCCover 525 | The access network can set this field to the |
| | index of the Data Rate Control (DRC) cover |
| | associated with the sector specified in this |
| | record |
| RABLength 527 | The access network can set this field to the |
| | number of slots over which the Reverse |
| | Activity Bit is transmitted, as shown in Table |
| | 3. |
| RABOffset 529 | The access network can set this field to |
| | indicate the slots in which a new Reverse |
| | Activity Bit is transmitted by this sector. The |
| | value (in slots) of RABOffset is the number |
| | the field is set to be multiplied by |
| | RABLength/8. |
| MACIndexMSBsIncluded | If this field is included, the access network |
| 531 | can set this field as follows. If |
| | MACIndexMSB fields are included in this |
| | message, then the access network can set this |
| | field to ‘1’. Otherwise, the access network |
| | can set this field to ‘0’. |
| MACIndexMSB 533 | Most significant bit if the Medium Access |
| | Control Index. If MACIndexMSBsIncluded |
| | field is not included in this message or if |
| | MACIndexMSBsIncluded field is equal to |
| | ‘0’, then the access network can omit this |
| | field. Otherwise, the access network can set |
| | this field as follows: |
| | The ith occurrence of this field corresponds to |
| | the ith occurrence of the PilotPN field in this |
| | message. The access network can set the ith |
| | occurrence of this field to the most significant |
| | bit of the 7-bit MACIndex assigned to the |
| | access terminal by the ith PilotPN. |
| RACChannelGain 535 | If MACIndexMSBsIncluded field is not |
| | included in this message or if |
| | MACIndexMSBsIncluded field is equal to |
| | ‘0’, then the access network can omit this |
| | field. Otherwise, the access network can set |
| | this field as follows: |
| | The ith occurrence of this field corresponds to |
| | the ith occurrence of the PilotPN field in this |
| | message. The access network can set the ith |
| | occurrence of this field to the RA Channel |
| | Gain to be used by the access terminal |
| | according to Table 4 of the ith PilotPN. The |
| | access terminal uses this information to |
| | demodulate the RA Channel. |
| DSCChannelGain 537 | If MACIndexMSBsIncluded field is not |
| | included in this message or if |
| | MACIndexMSBsIncluded field is equal to |
| | ‘0’, then the access network can omit this |
| | field. Otherwise, the access network can set |
| | this field to the power of the Data Source |
| | Control (DSC) channel relative to the pilot |
| | channel in units of −0.5 dB, in the range from |
| | zero to −12 dB, inclusive. The DSC channel |
| | is a reverse link channel used by the access |
| | terminal to indicate the Effective Isotropically |
| | Radiated Power (EIRP). |
| DSC 539 | If MACIndexMSBsIncluded field is not |
| | included in this message or if |
| | MACIndexMSBsIncluded field is equal to |
| | ‘0’, then the access network can omit this |
| | field. Otherwise, the access network can set |
| | this field as follows: The access network can |
| | set the ith occurrence of this field to the DSC |
| | associated with the ith cell specified by the |
| | PilotPN fields in this message |
| MCRevLinkParamsIncluded | If this field is included, the access network |
| 541 | can set this field as follows: |
| | If multiple reverse link carriers are included |
| | in this message, then the access network can |
| | set this to ‘1’, otherwise the access network |
| | can set this field to ‘0’. |
| MCRevLinkChannelCount | If the MCRevLinkParamsIncluded field is set |
| 543 | to ‘0’, or is not included, the access network |
| | can omit this field. Otherwise, the access |
| | network can set this field to the number of Nx |
| | carriers. |
| RLChannel 545 | If the MCRevLinkParamsIncluded field is set |
| | to ‘0’, or is not included, the access network |
| | can omit this field. Otherwise, the access |
| | network can set this to the channel record. If |
| | this Reverse Link Channel, RLChannel, is |
| | included, the access network can set the |
| | SystemType field of the Channel record to |
| | ‘0000’. |
| AssociatedFLChannel 547 | The Associated Forward Link carrier can be |
| | explicitly mentioned or can be just a number |
| | which indicates the position of corresponding |
| | Forward Link carrier. This field associates |
| | the reverse activity channels with the forward |
| | link carriers. |
| RAChannelWalshCover 549 | If the MCRevLinkParamsIncluded field is set |
| | to ‘0’, or is not included, the access network |
| | can omit this field. Otherwise, the access |
| | network can set this field to the Reverse |
| | Activity Channel Walsh Cover. |
| | The length is 7, if the approach of FIG. 2 is |
| | followed. The length is 8 if the approach of |
| | FIG. 3 is followed, where Walsh-Cover |
| | length is increased to 256, since the approach |
| | of FIG. 2 utilizes existing 128-length Walsh |
| | codes, and the approach of FIG. 3 proposes |
| | usage of 256-Walsh length. |
| | RAChannelWalshCover is applicable for |
| | these two approaches. |
| Reserved 551 | Variable |
| RABPosition 553 | If the MCRevLinkParamsIncluded field is set |
| | to ‘0’, or is not included, the access network |
| | can omit this field. Otherwise, the access |
| | network can set this to the position of the |
| | RAB symbol in the slot of the reverse activity |
| | channel. 0 means 1^{st} position, 1 means 2^{nd} |
| | position. This RABPosition is applicable for |
| | the process of FIG. 4. |

TABLE 2
DRCLength Encoding

| Field Value | DRCLength |
|---|---|
| (binary) | (slots) |
| ‘00’ | 1 |
| ‘01’ | 2 |
| ‘10’ | 4 |
| ‘11’ | 8 |

TABLE 3
Encoding of the RABLength Field

| Field Value | RABLength |
|---|---|
| (binary) | (slots) |
| ‘00’ | 8 |
| ‘01’ | 16 |
| ‘10’ | 32 |
| ‘11’ | 64 |

TABLE 4
Reverse Activity Channel Encoding

| Field Value | RAChannelGain |
|---|---|
| (binary) | (slots) |
| ‘00’ | −6 |
| ‘01’ | −9 |
| ‘10’ | −12 |
| ‘11’ | −15 |

It is recognized that the message formats of FIGS. 5A-5C are exemplary in nature, and can be organized in numerous ways and can utilize other information fields to convey the reverse activity information.

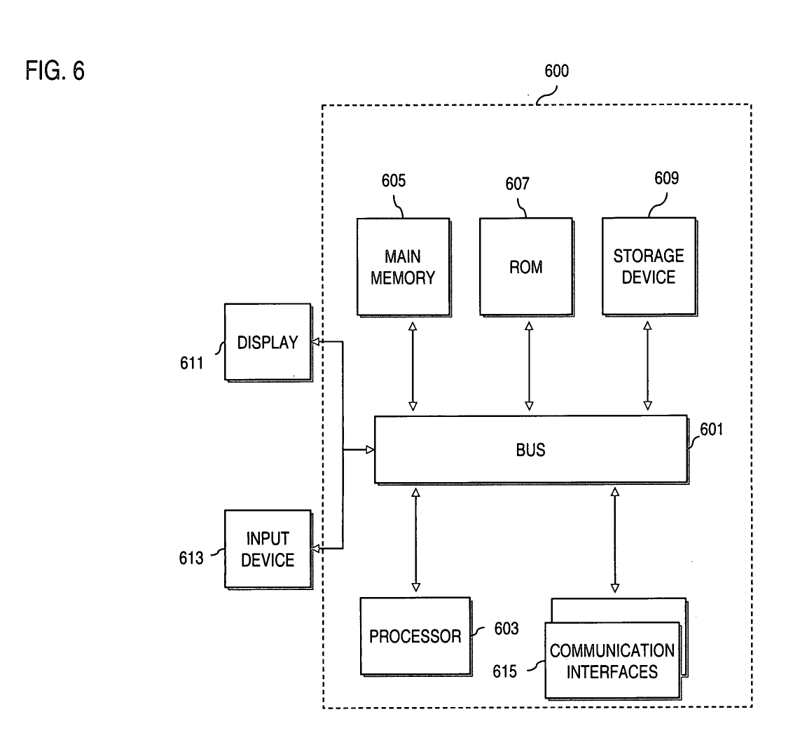

One of ordinary skill in the art would recognize that the processes for providing reverse activity information may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

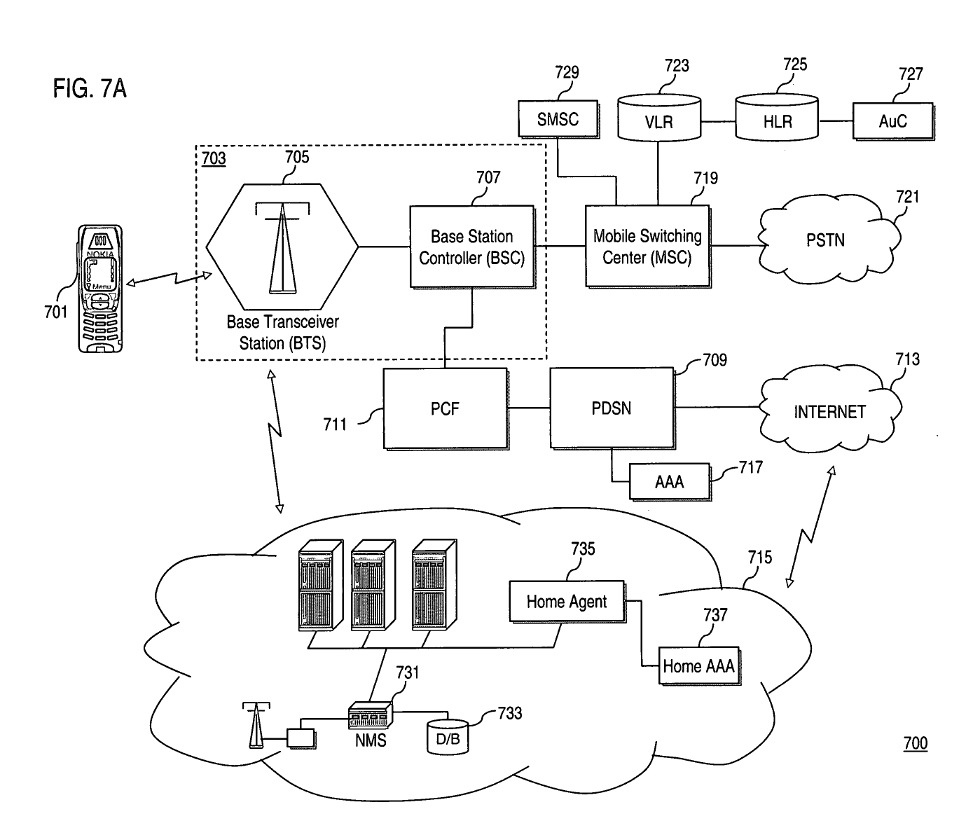

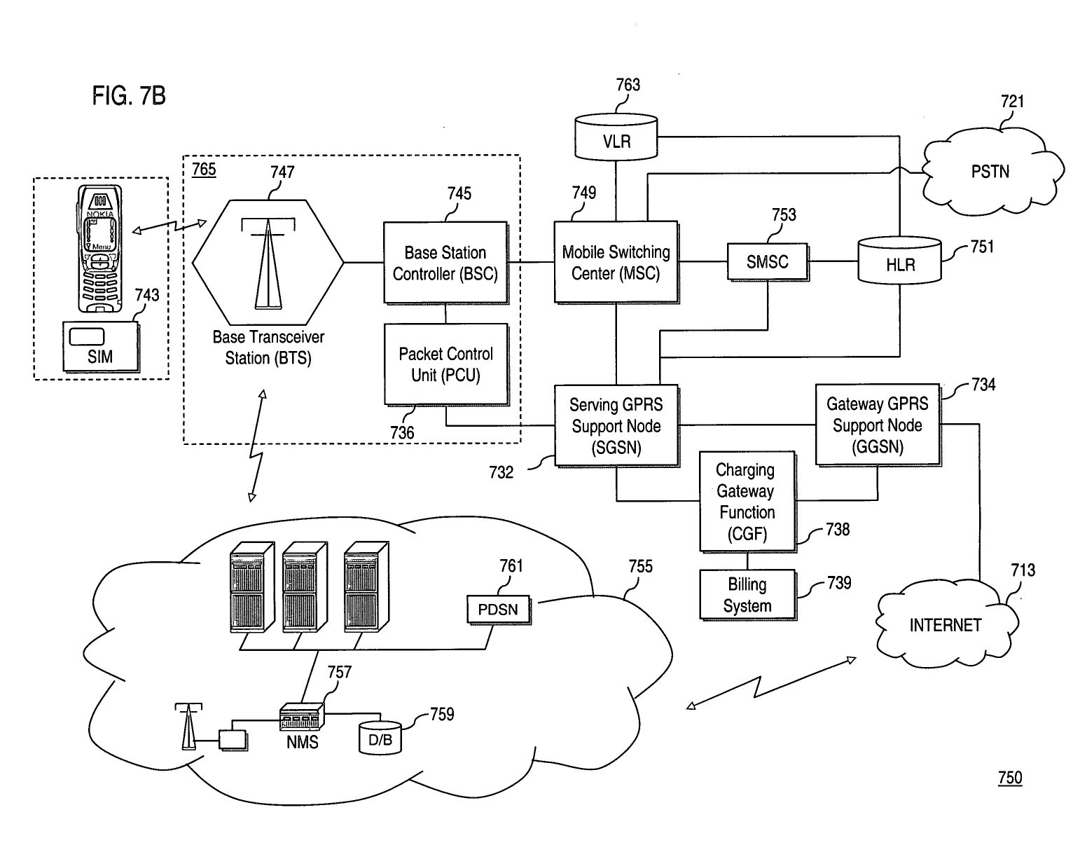

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit PCU (1336) and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 731 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 733 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

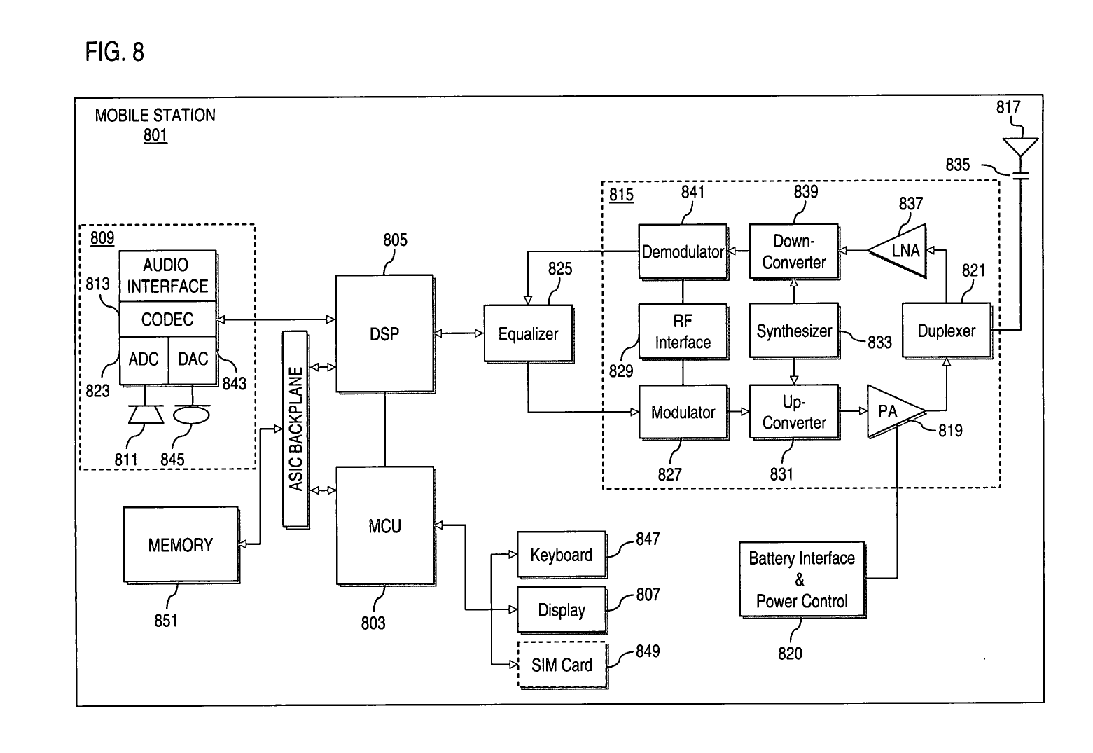

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 1005. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

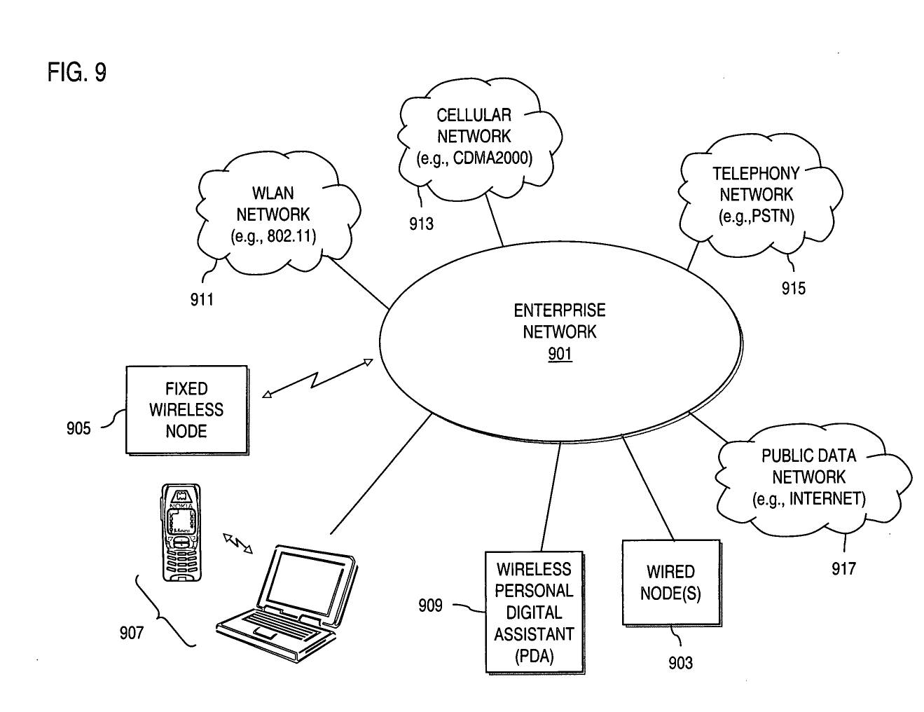

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 916 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
dynamically assigning a plurality of reverse activity channels to one or more of a plurality of carriers of a forward link, wherein the reverse activity channels transport information about a corresponding plurality of carriers of a reverse link; and
generating a message specifying information about the channel assignments and the information about the reverse link carriers.

2. A method according to claim 1, wherein the step of dynamically assigning includes designating a channel identifier for each of the reverse activity channels, the channel identifier being an orthogonal code.

3. A method according to claim 2, wherein the orthogonal code is a Walsh cover.

4. A method according to claim 1, further comprising:
transmitting the message to a terminal over the forward link using spread spectrum.

5. A method according to claim 1, wherein the number of reverse link carriers are different from the number of forward link carriers.

6. A method according to claim 1, wherein the number of reverse link carriers is M, M being an integer, the method further comprising:
reserving M-1 Walsh covers for the reverse activity channels per sector.

7. A method according to claim 1, wherein the information about the reverse link carriers are specified as reverse activity bits, the method further comprising:
transmitting the reverse activity bits corresponding to two of the reverse link carriers using one transmission slot, wherein the message specifies association of the reverse activity bits to the corresponding reverse link carriers.

8. A method according to claim 1, wherein the message includes,
a field specifying whether multiple reverse link carriers are supported,
a field specifying the number of reverse link carriers,
a field identifying channel records of the reverse link carriers, and
a field associating the reverse activity channels with the forward link carriers.

9. A method according to claim 8, wherein the message further includes a field specifying information about Walsh covers corresponding to the reverse activity channels.

10. A method according to claim 8, wherein the information about the reverse link carriers are specified as a reverse activity bit, the message further including a field specifying position of the reverse activity bit in a slot of the reverse activity channel.

11. An apparatus comprising:
a processor configured to dynamically assign a plurality of reverse activity channels to one or more of a plurality of carriers of a forward link, wherein the reverse activity channels transport information about a corresponding plurality of carriers of a reverse link,
wherein the processor is further configured to generate a message specifying information about the channel assignments and the information about the reverse link carriers.

12. An apparatus according to claim 11, wherein the processor is further configured to designate a channel identifier for each of the reverse activity channels as part of the dynamic assignment, the channel identifier being an orthogonal code.

13. An apparatus according to claim 12, wherein the orthogonal code is a Walsh cover.

14. An apparatus according to claim 11, further comprising:
a transceiver configured to transmit the message to a terminal over the forward link using spread spectrum.

15. An apparatus according to claim 11, wherein the number of reverse link carriers are different from the number of forward link carriers.

16. An apparatus according to claim 11, wherein the number of reverse link carriers is M, M being an integer, the processor being further configured to reserve M-1 Walsh covers for the reverse activity channels per sector.

17. An apparatus according to claim 11, wherein the information about the reverse link carriers are specified as reverse activity bits, the apparatus further comprising:
a transceiver configured to transmit the reverse activity bits corresponding to two of the reverse link carriers using one transmission slot, wherein the message specifies association of the reverse activity bits to the corresponding reverse link carriers.

18. An apparatus according to claim 11, further comprising:
a memory configured to store the message, wherein the message includes,
a field specifying whether multiple reverse link carriers are supported,
a field specifying the number of reverse link carriers,
a field identifying channel records of the reverse link carriers, and
a field associating the reverse activity channels with the forward link carriers.

19. An apparatus according to claim 18, wherein the message further includes a field specifying information about Walsh covers corresponding to the reverse activity channels.

20. An apparatus according to claim 18, wherein the information about the reverse link carriers are specified as a reverse activity bit, the message further including a field specifying position of the reverse activity bit in a slot of the reverse activity channel.

21. A system comprising the apparatus of claim 11, the system comprising: a packet data service node configured to route packets to the terminal.

22. A method comprising:
receiving a message specifying information about channel assignments and information about reverse link carriers from a network, wherein the network dynamically assigns a plurality of reverse activity channels to one or more of a plurality of carriers of a forward link, wherein the reverse activity channels transport the information about corresponding plurality of reverse link carriers; and storing the message.

23. A method according to claim 22, wherein the dynamically assignment includes designating a channel identifier for each of the reverse activity channels, the channel identifier being an orthogonal code.

24. A method according to claim 23, wherein the orthogonal code is a Walsh cover.

25. A method according to claim 22, wherein the network is a spread spectrum system.

26. A method according to claim 22, wherein the number of reverse link carriers are different from the number of forward link carriers.

27. A method according to claim 22, wherein the number of reverse link carriers is M, M being an integer, and M-1 Walsh covers are reserved for the reverse activity channels per sector of the network.

28. A method according to claim 22, wherein the information about the reverse link carriers are specified as reverse activity bits corresponding to two of the reverse link carriers using one transmission slot, wherein the message specifies association of the reverse activity bits to the corresponding reverse link carriers.

29. A method according to claim 22, wherein the message includes,
a field specifying whether multiple reverse link carriers are supported,
a field specifying the number of reverse link carriers,
a field identifying channel records of the reverse link carriers, and
a field associating the reverse activity channels with the forward link carriers.

30. A method according to claim 29, wherein the message further includes a field specifying information about Walsh covers corresponding to the reverse activity channels.

31. A method according to claim 29, wherein the information about the reverse link carriers are specified as a reverse activity bit, the message further including a field specifying position of the reverse activity bit in a slot of the reverse activity channel.

32. An apparatus comprising:
a processor configured to receive a message specifying information about channel assignments and information about reverse link carriers from a network, wherein the network dynamically assigns a plurality of reverse activity channels to one or more of a plurality of carriers of a forward link, wherein the reverse activity channels transport the information about corresponding plurality of reverse link carriers; and a memory coupled to the processor and configured to store the message.

33. An apparatus according to claim 32, wherein the dynamically assignment includes designating a channel identifier for each of the reverse activity channels, the channel identifier being an orthogonal code.

34. An apparatus according to claim 33, wherein the orthogonal code is a Walsh cover.

35. An apparatus according to claim 32, wherein the network is a spread spectrum system.

36. An apparatus according to claim 32, wherein the number of reverse link carriers are different from the number of forward link carriers.

37. An apparatus according to claim 32, wherein the number of reverse link carriers is M, M being an integer, and M-1 Walsh covers are reserved for the reverse activity channels per sector of the network.

38. An apparatus according to claim 32, wherein the information about the reverse link carriers are specified as reverse activity bits corresponding to two of the reverse link carriers using one transmission slot, wherein the message specifies association of the reverse activity bits to the corresponding reverse link carriers.

39. An apparatus according to claim 32, wherein the message includes,
a field specifying whether multiple reverse link carriers are supported,
a field specifying the number of reverse link carriers,
a field identifying channel records of the reverse link carriers, and
a field associating the reverse activity channels with the forward link carriers.

40. An apparatus according to claim 39, wherein the message further includes a field specifying information about Walsh covers corresponding to the reverse activity channels.

41. An apparatus according to claim 39, wherein the information about the reverse link carriers are specified as a reverse activity bit, the message further including a field specifying position of the reverse activity bit in a slot of the reverse activity channel.

42. A system comprising the apparatus of claim 32.

43. An apparatus according to claim 32, further comprising:
a transceiver configured to communicate with the network;
means for receiving user input to initiate communication with the network; and
a display configured to display the user input.
